(19) United States
(12) Patent Application Publication
(10) Pub. No.: US 2010/0207378 A1
(43) Pub. Date: Aug. 19, 2010

(54) METHOD FOR DELIVERING SECRET INFORMATION AS A POSTED LETTER

(75) Inventors: Esko Maaranen, Helsinki (FI); Miika Finnberg, Helsinki (FI); Risto Nokelainen, Helsinki (FI); Eino Korkiakoski, Helsinki (FI)

Correspondence Address: YOUNG & THOMPSON, 209 Madison Street, Suite 500, Alexandria, VA, 22314, US

(73) Assignee: MAIL SYSTEMS OY, Helsinki (FI)

(21) Appl. No.: 12/599,610

(22) PCT Filed: May 8, 2008
(86) PCT No.: PCT/FI2008/050255

§ 371 Date: Mar. 29, 2010

(30) Foreign Application Priority Data
May 10, 2007 (FI) 20075339

(51) Int. Cl. B42D 15/00

(52) U.S. Cl. 283/106; 283/116

(57) ABSTRACT

The invention relates to a method for delivering secret information to a client as a posted letter. In the method, the information, such as a code, is printed and enclosed into an envelope on which the client's address information is printed. According to the invention, a print carrier (1) is provided for printing the secret code, such as a PIN number (2), and concealed client identification information (3) on a same printing surface; the print carrier is glued and folded to form a closed envelope (4) in such manner that the secret code is enclosed inside the envelope but the identification information remains visible; and the identification information is read and used for printing the client's address information (5) onto the closed envelope.

### FIELD OF THE INVENTION

The invention relates to a method as defined in the preamble of claim 1 for delivering information that should be maintained secret, such as for example a PIN number, to a client as a posted letter.

### BACKGROUND OF THE INVENTION

There are many practical applications where secret information, such as codes, for example PIN numbers and the like, is delivered to clients by post. This all is based on absolute data security in terms of processing and posting this type of information. For example PIN numbers are presently posted by using a pre-closed envelope containing a note paper made from self-copying paper. The number is printed on the note paper by a clamping, pressing or striking printer, so that the printed number is formed only on the self-copying note paper inside the envelope. When the name and address of the recipient are then printed on the envelope, the number is enclosed inside a closed letter so that an outsider can access it only by violating the privacy of letters.

However, the known method has several drawbacks. A specific kind of paper must be used in the envelopes, not showing pressure marks from the printing and being darkened on the interior over the printing area to prevent the code from being read by raying. Furthermore, another type of paper, i.e. self-copying paper, must be used as the note paper. Consequently, the complete posted letters become relatively expensive. Also, when printing codes by a laser printer, a specific form is used in which the code is printed under an adhesive label. The form is expensive, difficult to print, requires a separate envelope and is also difficult to put into the envelope automatically due to the asymmetrical thickness of the form.

### OBJECTIVE OF THE INVENTION

The objective of the invention is to eliminate the drawbacks of the prior art referred to above. One specific objective of the invention is to disclose a new type of method for producing posted letters containing secret information, such as secret codes. One further objective of the invention is to enable production of these posted letters using only one type of paper. One further objective of the invention is to enable a cost-effective manner of printing which does not require a hammering printer or pre-processed form paper.

### SUMMARY OF THE INVENTION

In the method according to the invention for delivering secret information, such as a code, to a client as a posted letter, the information is printed and enclosed into an envelope on which the client's address is printed. According to the invention, a print carrier is provided for printing the secret information, such as the secret code, and concealed client identification information on a same printing surface. Then the print carrier is glued and folded into a closed envelope in such manner that the secret information is enclosed inside the envelope but the concealed identification information remains visible. Finally, the identification information is read and used for printing the client's address onto the closed envelope.

The method according to the invention relates and is applicable to processing any information that is to be maintained secret and delivered to a client in printed form, although it has mainly been developed for processing PIN numbers and other similar secret number codes. Therefore, although the following description mainly includes references to codes and in particular to PIN numbers, the invention is not limited merely to applications relating to codes, but all information that is to be maintained secret falls under the application of the invention.

In the method according to the invention, any material that can be folded and closed to form a posted letter can basically be used as the print carrier, but in practice, the most suitable material is a sufficiently thin paper which can be used either directly as sheets of paper or as a paper web which is cut into sheets at a suitable stage.

In one embodiment of the invention, pre-printed sheets of paper are used as the print carrier for printing the secret code and the concealed client identification information on the same printing surface. Although both pieces of information are visible to everyone who sees the paper and processes it, data security is ensured because the concealed identification information does not reveal any information that could be read or understood about the client. It is only a bar code or other similar machine readable code by which a suitable system is able to recognize the given client.

However, if one finds that the state of the code and the identification information being visible on the same paper contains a data security threat, a second embodiment of the invention has been developed, in which partly pre-printed sheets of paper are used as the print carrier, in which case the concealed client identification information is pre-printed onto the sheet of paper. In this manner, the secret code or other information corresponding to the identification information can be printed on the sheet of paper at a later stage on the base of the identification information. Printing can be performed by reading the identification information by a machine for example not until the letter-folding, in which case an external user only sees the sheet of paper provided with the identification information being fed into the folding machine and a closed envelope coming out of the folding machine with only the same identification information visible.

In a third embodiment of the invention, blank sheets of paper are used as the print carrier. In this case, the secret code and the identification information are not printed until substantially in conjunction with the letter-folding, i.e. for example inside the closed envelope defined by the folding machine. In this manner, blank sheets of paper enter the folding machine and closed envelopes come out, containing the secret code with only the identification information in code form visible, which does not yield any information about the given client to anyone who might see the envelope.

In the method according to the invention, the concealed client identification information is printed or will be printed preferably to the edge of the sheet of paper, so that in the folding machine, the sheet can be folded nearly in half. In this manner, only a small strip at one edge of the sheet remains unfolded, this strip comprising said identification information. Of course it is possible within the scope of the inventive idea to fold the sheet in half for a smaller portion, for example when one wishes to use lower envelopes by cutting the unfolded portion comprising the identification information completely off, so that there remains only an even-edged folded and closed envelope.

In the method according to the invention, the client's name and address are thus printed on the closed envelope that is finished in all other respects. Since this type of envelope also shows the concealed client identification information, an additional check can be performed after printing the address by reading with a machine the identification information and the name and address, verifying their correspondence.

Before the letter is delivered to posting, the unfolded portion extending outside the closed envelope, i.e. the portion containing the concealed identification information, can be removed. This portion may be cut off, or it may have been pre-perforated so that it can be torn off before posting the envelope.

Furthermore, it should be noted that although the section above discusses pre-printed, partly printed and blank sheets of paper, it refers merely to the possible printing of the code and the identification information. Therefore, the paper used may also contain any printing, text, images, advertisements, logos etc. which are not significant per se for the standpoint of the method according to the invention.

The method according to the invention provides considerable advantages compared to the prior art. The method according to the invention does not require two different printers or printing on both sides of the sheet of paper. This ensures that the printing is fast, simple and affordable. Furthermore, there are no specific requirements for the grade of paper used, and only one type of paper is used, so this too provides cost-efficiency compared to the prior art. Furthermore, because the printing is made onto the paper that forms the envelope, there is no need for a separate letter inside the envelope, which saves paper and posting expenses in terms of lighter shipments. The method according to the invention is also very safe. The secret code or other secret information and the client's name or address are not visible and readable simultaneously at any stage of the process. The recipient's name and address are printed on the envelope only after it has been finally closed.

### LIST OF FIGURES

In the following section, the invention will be described in detail with reference to the accompanying drawings, in which

FIG. 1 schematically shows a first embodiment of the invention,

FIG. 2 schematically shows a second embodiment of the invention,

FIG. 3 schematically shows a third embodiment of the invention and

FIG. 4 schematically shows a fourth embodiment of the invention.

### DETAILED DESCRIPTION OF THE INVENTION

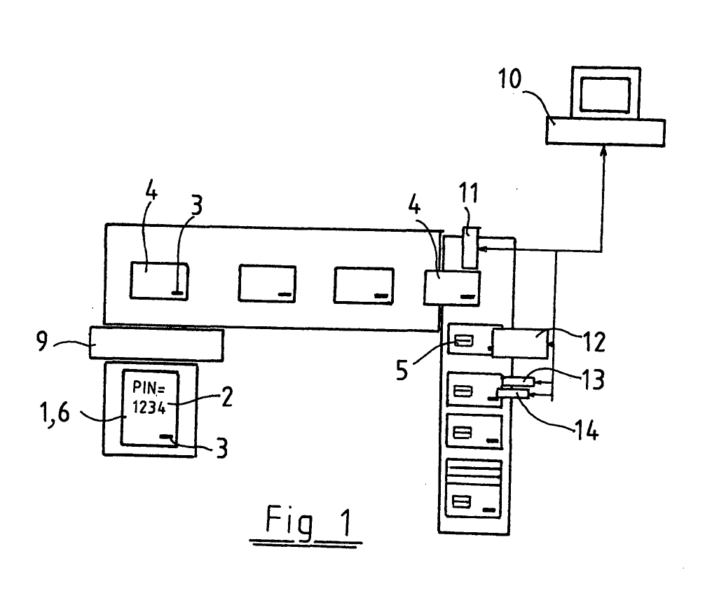

FIG. 1 shows schematically one method according to the invention with sheets of paper used as a print carrier 1 and initially comprising a set of pre-printed sheets of paper 6 to be posted. A secret code 2, such as a PIN number, is printed on each sheet of paper, and client identification information 3 in concealed form is printed near one of the short edges of the A4 sheet. The sheet printed in this manner is led to a folding machine 9 where the sheet is folded nearly in half, i.e. nearly to size A5, so that the identification information 3 near the short edge remains at least partly visible. In conjunction with the folding, the paper is also glued and closed to form a closed envelope 4.

The closed envelope 4 is led to a reading unit 11 connected to a central unit 10 of the system for reading the identification information which is used by the central unit 10 to direct a printer 12 to print address information 5, i.e. the client's name and address, corresponding to the identification information onto the envelope.

After this, the envelope that is ready to be posted passes through a checking unit where cameras 13 and 14 connected to the central unit 10 read the address information and the identification information and compare them, verifying their correspondence. Then the envelopes can be stacked and delivered to posting.

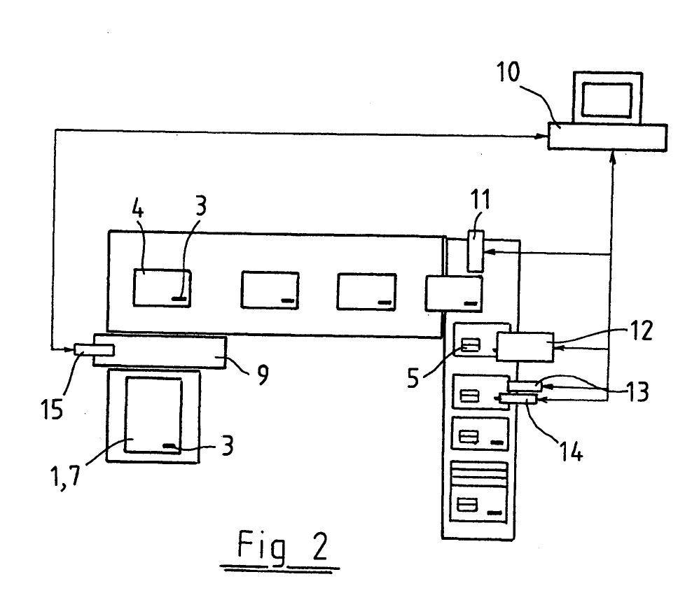

FIG. 2 shows a second embodiment of the invention in which a partly pre-printed sheet of paper 7 is used, i.e. a sheet in which the client identification information 3 in concealed form is pre-printed on the top edge. These sheets are led to the folding machine 9 which includes an integrated printer 15 connected to the central unit 10 and also comprising a reader device for reading the identification information at the edge of the sheet.

Reading the identification information, using this for printing the secret code on the sheet of paper within the direction of the central unit 10, and folding, gluing and closing the sheet of paper to form a closed envelop 4 immediately after printing take place inside the folding machine 9.

The closed envelope 4 is led to the reading unit 11 connected to the central unit 10 of the system for reading the identification information, which information is used by the central unit 10 to direct the printer 12 to print the address information 5, i.e. the client's name and address, corresponding to the identification information onto the envelope.

After this, the envelope that is ready to be posted passes though a checking unit where cameras 13 and 14 connected to the central unit 10 read the address information and the identification information and compare them, verifying their correspondence. Then the envelopes can be stacked and delivered to posting.

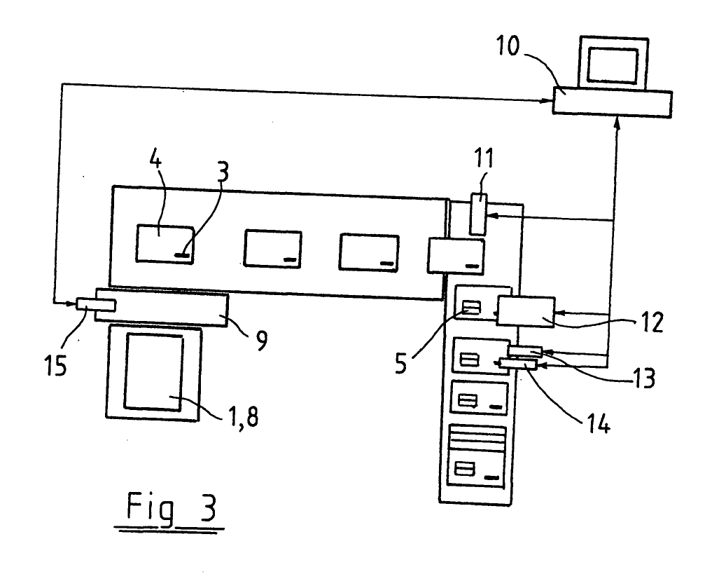

FIG. 3 shows a third embodiment of the invention using a blank, i.e. empty, sheet of paper or a pre-printed form 7. The empty sheet is led to the folding machine 9 including the integrated printer 15 connected to the central unit 10. Inside the folding machine, the secret code and the identification information are printed almost simultaneously by the printer 15 on the empty sheet, after which the sheet is immediately folded, glued and closed to form a closed envelope. In this manner, the secret code is enclosed inside the closed letter and the identification information 3 is visible over the envelope.

The closed envelope 4 is led to the reading unit 11 connected to the central unit 10 of the system for reading the identification information, which information is used by the central unit 10 to direct the printer 12 to print the address information 5, i.e. the client's name and address, corresponding to the identification information onto the envelope.

After this, the envelope that is ready to be posted passes though a checking unit where cameras 13 and 14 connected to the central unit 10 read the address information and the identification information and compare them, verifying their correspondence. Then the envelopes can be stacked and delivered to posting.

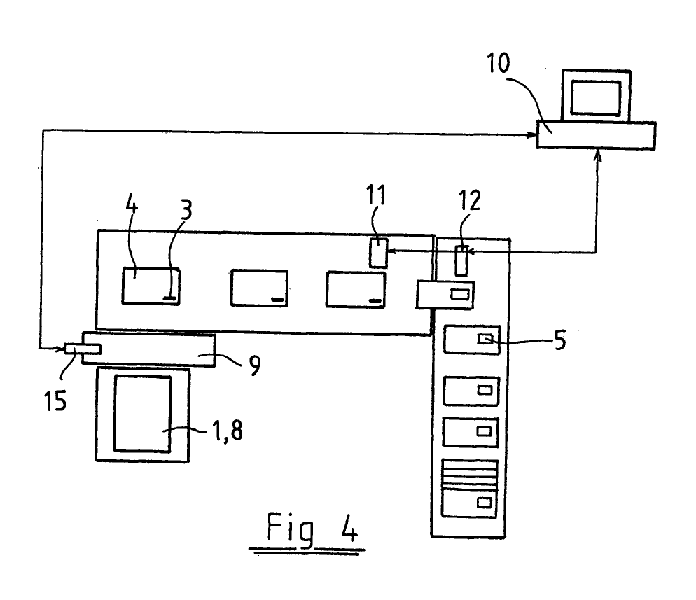

FIG. 4 shows a fourth embodiment of the invention using a blank, i.e. empty, sheet of paper 7. The empty sheet is led to the folding machine 9 including the integrated printer 15 connected to the central unit 10. Inside the folding machine, the secret code and the identification information are printed by the printer 15 almost simultaneously on the empty sheet, after which the sheet is immediately folded, glued and closed to form a closed envelope. In this manner, the secret code is enclosed inside the closed letter and the identification information 3 is visible over the envelope.

The closed envelope 4 is led to the reading unit 11 connected to the central unit 10 of the system for reading the identification information, which information is used by the central unit 10 to direct the printer 12 to print the address information 5, i.e. the client's name and address, corresponding to the identification information onto the envelope.

After reading the identification information 3, either immediately or after having printed the address information, the unfolded portion of the sheet, i.e. the portion comprising the visible and readable identification information in code form, is cut off from the edge of the closed envelope. In this manner, the envelope becomes thinner and ready to be posted. Correspondingly, the narrow strip comprising only unfolded paper and including the identification information used for printing the address information could be removed from the top edge of the finished envelopes in the embodiments of FIGS. 1 to 3.

The invention is not limited merely to the examples referred to above; instead many variations are possible within the scope of the inventive idea defined by the claims.

1. A method for delivering secret information to a client as a posted letter, in which method the information is printed and enclosed inside an envelope on which the client's address information is printed, characterized in that a print carrier (1) is provided for printing the secret information (2) and concealed client identification information (3) on a same printing surface; the print carrier is glued and folded to form a closed envelope (4) in such manner that the secret information is enclosed inside the envelope but the identification information remains visible; and the identification information is read and used for printing the client's address information (5) onto the closed envelope.

2. The method according to claim 1, characterized in that the secret information is a secret code (2).

3. The method according to claim 1, characterized in that a sheet of paper or a paper web which is cut into sheets before folding are used as the print carrier (1).

4. The method according to claim 1, characterized in that pre-printed sheets of paper (6), on which the secret code (2) and the concealed client identification information (3) are printed, are used as the print carrier (1).

5. The method according to claim 1, characterized in that partly pre-printed sheets of paper (7), on which the concealed client identification information (3) is printed, are used as the print carrier (1).

6. The method according to claim 5, characterized in that the secret code (2) is printed on the sheet of paper on the base of the identification information substantially in conjunction with the letter-folding.

7. The method according to claim 1, characterized in that blank sheets of paper (8), on which the secret code and the identification information are not printed until substantially in conjunction with the letter-folding, are used as the print carrier (1).

8. The method according to claim 1, characterized in that after having printed the address onto the letter, the correctness of the printed address is checked using the visible identification information.

9. The method according to claim 1, characterized in that before the letter is delivered to posting, the portion comprising the identification information is removed, such as cut off, from it.

10. The method according to claim 2, characterized in that a sheet of paper or a paper web which is cut into sheets before folding are used as the print carrier (1).

11. The method according to claim 2, characterized in that pre-printed sheets of paper (6), on which the secret code (2) and the concealed client identification information (3) are printed, are used as the print carrier (1).

12. The method according to claim 3, characterized in that pre-printed sheets of paper (6), on which the secret code (2) and the concealed client identification information (3) are printed, are used as the print carrier (1).

13. The method according to claim 2, characterized in that partly pre-printed sheets of paper (7), on which the concealed client identification information (3) is printed, are used as the print carrier (1).

14. The method according to claim 3, characterized in that partly pre-printed sheets of paper (7), on which the concealed client identification information (3) is printed, are used as the print carrier (1).

15. The method according to claim 2, characterized in that blank sheets of paper (8), on which the secret code and the identification information are not printed until substantially in conjunction with the letter-folding, are used as the print carrier (1).

16. The method according to claim 3, characterized in that blank sheets of paper (8), on which the secret code and the identification information are not printed until substantially in conjunction with the letter-folding, are used as the print carrier (1).

17. The method according to claim 2, characterized in that after having printed the address onto the letter, the correctness of the printed address is checked using the visible identification information.

18. The method according to claim 3, characterized in that after having printed the address onto the letter, the correctness of the printed address is checked using the visible identification information.

19. The method according to claim 4, characterized in that after having printed the address onto the letter, the correctness of the printed address is checked using the visible identification information.

20. The method according to claim 5, characterized in that after having printed the address onto the letter, the correctness of the printed address is checked using the visible identification information.
